(19) United States
(12) Patent Application Publication
(10) Pub. No.: US 2008/0185832 A1
(43) Pub. Date: Aug. 7, 2008

(54) Seat Belt System

(76) Inventors: Joachim Biller, Lorch (DE); Bernd Gombert, Grafrath (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/064,776

(22) PCT Filed: Aug. 29, 2006
(86) PCT No.: PCT/EP06/65759

§ 371 Date: Feb. 25, 2008

(30) Foreign Application Priority Data
Aug. 30, 2005 (DE) 10 2005 041 101.0

(51) Int. Cl. B60R 22/46; G06F 19/00

(52) U.S. Cl. 280/806; 701/45

(57) ABSTRACT

A seat belt system for a motor vehicle with a belt roller (14) and a belt strap (16) wound on the belt roller (14) further has a braking arrangement (17) that can be actuated by an actuator (32) for braking movement of the belt strap (16), the braking arrangement (17) being equipped with an arrangement (20, 38, 40) for automatically increasing an actuating force generated by the actuator (32), the actuator (32) being connected to an electronic control unit (35). The electronic control unit (35) controls the actuator (32) as a function of at least one occupant-specific and/or situation-specific parameter in order to effect braking of the movement of the belt strap (16) that is adapted thereto.

### CROSS-REFERENCE TO RELATED APPLICATION

This application is a U.S. national stage application of International Application No. PCT/EP2006/065759 filed Aug. 29, 2006, which designates the United States of America, and claims priority to German Application number 10 2005 041 101.0 filed Aug. 30, 2005, the contents of which are hereby incorporated by reference in their entirety.

### TECHNICAL FIELD

The invention relates to a seat belt system comprising a belt roller and a belt strap wound on the belt roller.

### BACKGROUND

Modern safety belt systems intended for use in motor vehicles typically feature a rotatable belt roller on which is wound a belt strap, as well as a mechanism that is designed for example in the form of a ratchet device, centrifugal device or inertial device, which in the event of a crash ensures blocking of the belt roller and thus braking of a winding movement of the belt strap by the belt roller. Such systems further typically feature a belt pretensioner fitted on the belt roller or a belt lock, which pulls the belt strap tight against the body of a vehicle occupant immediately before a crash and thus compensates for the so-called belt slack. In order to prevent injuries caused by the safety belt system a belt force limiter is further typically provided, which limits the force effect exerted by the belt strap on the vehicle occupant, for example by distortion of a torsion bar after a predetermined belt force.

When a vehicle assistance system or a crash sensor detects an upcoming crash situation, a corresponding signal is forwarded to an electronic control unit that in turn triggers a activation mechanism of the belt pretensioner and thus ensures that the belt pretensioner is triggered. Mechanical systems having a pre-tensioned spring or pyrotechnic systems in which the tightening of the belt is effected by means of a pyrotechnic propellant are used as activation mechanisms for the belt pretensioner. Once triggered these systems become ineffective and must therefore be replaced after a crash. By contrast reversible activation systems, which use e.g. a highly dynamic electric motor, can be used repeatedly. When the belt pretensioner is triggered the belt strap is tightened by up to 300 mm within 5 to 20 ms, so that the vehicle occupant is pulled into an optimal seating position and the belt strap also sits tight against the body, in the event that the vehicle occupant is wearing thick clothes.

In a crash itself the belt roller and thus the belt strap is blocked by the mechanism that is designed for example in the form of a ratchet device, centrifugal device or inertial device The triggering of the blocking mechanism can in turn be effected either mechanically or electronically by the electronic control unit, for example in reaction to a corresponding signal from an acceleration sensor or centrifugal sensor. After the blocking mechanism has been triggered the flow of forces in the safety belt system is conducted through the torsion bar which, as mentioned above, distorts after a predetermined belt load and thus limits the force effect exerted by the belt strap on the vehicle occupant. In this way the force exerted on the head and chest area of the occupant can be reduced by the belt system.

According to most currently known safety belt systems a belt force level is determined in excess of which a distorsion of the torsion bar and thus a limitation of the belt force is possible. Several systems allow for a one-time mechanical switchover between two different belt force levels. However in all systems it is necessary to determine the belt force level(s) for a distorsion of the torsion bar as early as during construction of the system, for example by means of suitable dimensioning of the torsion bar. Reference is typically made for this purpose to average values for the height and weight of a vehicle occupant, the seating position, the driving/crash situation, etc.

In the event of a crash there is consequently a danger for example in the case of vehicle occupants who are very small and/or light that the belt force level for sufficient distorsion of the torsion bar is not achieved. This leads to an excessive force effect particularly on the head and chest area of these individuals and thus to an increased risk of injury. By contrast in the case of vehicle occupants who are very tall and/or heavy an insufficient belt system braking effect can be caused by the belt force limitation, so that there is a risk of these individuals possibly hitting the steering wheel through the airbag in the event of a crash. Accordingly the passive safety afforded by known safety belt systems for an “average” vehicle occupant, i.e. a person of average height and average weight, may possibly be significantly greater than for a very small and light person or a very tall and heavy person.

Furthermore these systems are not in a position to react to a change in other parameters, such as e.g. an “out of position” vehicle occupant or specific driving or crash situations, which can be characterized for example by a certain driving speed, a certain crash pulse, and the respective environmental situation.

### SUMMARY

An adaptive safety belt system may enable individual controlling of the force effect exerted on a vehicle occupant by the belt strap in the event of a crash. According to an embodiment, a safety belt system for a motor vehicle may comprise a belt roller, a belt strap wound on the belt roller, and a braking arrangement that can be activated by an actuator for braking a movement of the belt strap, wherein the braking arrangement is fitted with an arrangement for self-energizing of an activation force generated by the actuator, and wherein the actuator is connected to an electronic control unit that is configured to control the actuator as a function of at least one occupant-specific and/or situation-specific parameter in order to effect a braking of the movement of the belt strap that is adapted thereto.

According to a further embodiment, the electronic control unit may be configured to draw on a parameter that characterizes the weight of an occupant of a motor vehicle fitted with the safety belt system and/or that characterizes the seating position of the occupant as the at least one occupant-specific and/or situation-specific parameter. According to a further embodiment, the electronic control unit can be configured to draw on a parameter that characterizes the speed of a motor vehicle fitted with the safety belt system, the crash pulse in a crash and/or one or a plurality of parameter(s) that characterize(s) the environmental situation as the at least one occupant-specific and/or situation-specific parameter. According to a further embodiment, the safety belt system may comprise corresponding sensors for recording the at least one occupant-specific and/or situation-specific parameter. According to a further embodiment, the electronic control unit may be configured to determine as a function of the at least one occupant-specific and/or situation-specific parameter a reference value for at least one measurement that characterizes the process of braking the movement of the belt strap. According to a further embodiment, the electronic control unit may be preferably configured to control the actuator as a function of the reference value for the at least one measurement that characterizes the process of braking the movement of the belt strap.

According to another embodiment, a method for controlling a safety belt system for a motor vehicle, said system comprising a belt roller and a belt strap wound on the belt roller, may comprise the following steps: -Recording of at least one occupant-specific and/or situation-specific parameter, and -Controlling of an actuator that is configured to activate a braking arrangement for braking a movement of the belt strap, with said braking arrangement being equipped with an arrangement for self-energizing of an activation force generated by the actuator, by means of an electronic control unit as a function of the at least one recorded occupant-specific and/or situation-specific parameter in order to effect a braking of the movement of the belt strap that is adapted thereto.

According to a further embodiment, the electronic control unit may draw on a parameter that characterizes the weight of an occupant of a motor vehicle fitted with the safety belt system and/or that characterizes the seating position of the occupant as the at least one occupant-specific and/or situation-specific parameter. According to a further embodiment, the electronic control unit may draw on a parameter that characterizes the speed of a motor vehicle fitted with the safety belt system, the crash pulse in a crash and/or one or a plurality of parameter(s) that characterize(s) the environmental situation as the at least one occupant-specific and/or situation-specific parameter. According to a further embodiment, the method may further comprise the following step: -Determination by means of the electronic control unit of a reference value for at least one measurement that characterizes the process of braking the movement of the belt strap as a function of the at least one occupant-specific and/or situation-specific parameter. According to a further embodiment, the electronic control unit may control the actuator as a function of the reference value for the at least one measurement that characterizes the process of braking the movement of the belt strap. According to a further embodiment,

### BRIEF DESCRIPTION OF THE DRAWINGS

A preferred exemplary embodiment of a safety belt system according to the invention is now described in more detail with reference to the appended schematic figures, in which

FIG. 1 shows a relevant longitudinal section through the safety belt system according to an embodiment;

FIG. 2 shows a plan view of a wedge arrangement which is employed in the safety belt system according an embodiment shown in FIG. 1; and

FIG. 3 shows the balance of forces on a first wedge from the wedge arrangement shown in FIG. 2.

### DETAILED DESCRIPTION

The safety belt system according to various embodiments comprises a braking arrangement for braking a movement of the belt strap, said braking arrangement being capable of being activated by an actuator. Braking of the movement of the belt strap in the safety belt system according to the invention can be achieved by means of braking a rotary motion of a rotatable belt roller for winding/unwinding the belt strap from/on the belt roller, but also by the application of a braking force to the belt strap itself. In other words, the braking arrangement that can be activated by an actuator can act upon the belt roller but also on the belt strap itself.

The braking arrangement of the safety belt system according to an embodiment may be equipped with a self-energizing arrangement for an activation force generated by the actuator. By means of such a self-energizing arrangement the activation force to be exerted by the actuator in order to achieve a desired braking effect can be significantly reduced. Consequently an actuator can be used that is compact in design and lightweight. The braking arrangement of the safety belt system according to an embodiment, thus, has a sufficiently low volume that it can be accommodated in the available installation space that is typically very limited in modern motor vehicles, for example in the B-pillar of the motor vehicle.

Lastly the actuator for activating the braking arrangement in the safety belt system according to an embodiment may be linked with an electronic control unit. The electronic control unit is configured to control the actuator as a function of at least one occupant-specific and/or situation-specific parameter in order to effect a braking of the movement of the belt strap, said braking being adapted to at least one occupant-specific and/or situation-specific parameter. While the actuator is controlled in real time as a function of the at least one occupant-specific and/or situation-specific parameter, the braking of the movement of the belt strap in the event of a crash also takes place in real time as a function of this parameter. Consequently an individual adjustment of the force acting via the belt strap on a vehicle occupant is possible according to the at least one occupant-specific and/or situation-specific parameter. In comparison with conventional systems the safety belt system according to an embodiment, thus, affords significantly enhanced passive safety.

The electronic control unit is preferably configured to draw on a parameter that characterizes the weight of an occupant of a motor vehicle fitted with the safety belt system according to an embodiment and/or that characterizes the seating position of the occupant as the at least one occupant-specific and/or situation-specific parameter. By controlling the actuator that activates the braking arrangement for braking the movement of the belt strap as a function of the weight of a vehicle occupant the force acting on the vehicle occupant via the belt strap can advantageously be adjusted according to the weight of this occupant. In the event of a crash individuals who are small and/or light for example can be reliably protected from an excessive force effect via the belt strap by corresponding controlling of the actuator and a concomitant limitation of the exerted braking force. By contrast in the case of vehicle occupants who are tall and/or heavy the actuator can be controlled so that the braking force exerted by the braking arrangement for braking the movement of the belt strap is sufficiently high to prevent these individuals possibly hitting the steering wheel through the airbag in the event of a crash. Thus the risk of injury can be significantly reduced both for individuals who are small and/or light as well as for individuals who are tall and/or heavy.

By taking account of the actual seating position of the occupant of the motor vehicle fitted with the safety belt system according to an embodiment when triggering the actuator that activates the braking arrangement for braking the movement of the belt strap, allowance can be made for example for an “out of position” i.e. for a vehicle occupant position that deviates from a “typical” seating position. In other words, the activation force exerted by the actuator and/or the braking force exerted by the braking arrangement for braking the movement of the belt strap can be adjusted depending on whether the vehicle occupant is located in a typical seating position or is “out of position”. Depending on the type of “out of position” the activation force exerted by the actuator and/or the braking force exerted by the braking arrangement can be increased or reduced as compared to the activation force and/or braking force exerted in the case of a typical seating position. Thus the occupant can be much better protected from injuries in a crash, especially if his seating position deviates from the typical seating position.

The electronic control unit can be further configured to draw on a parameter that characterizes the speed of a motor vehicle fitted with the safety belt system according to an embodiment, the crash pulse in a crash and/or one or a plurality of parameter(s) that characterize(s) the environmental situation as the at least one occupant-specific and/or situation-specific parameter. For example the actuator that activates the braking arrangement for braking the movement of the belt strap can be controlled such that the activation force exerted by the actuator and/or the braking force exerted by the braking arrangement rises as the speed of the motor vehicle increases and/or as the crash pulse increases, and falls as the speed of the motor vehicle decreases and/or the crash pulse decreases. The parameters that characterize the environmental situation can be for example the temperature, the nature of the road, the nature of an obstacle in a crash, etc. By taking such parameters into consideration an optimal reaction by the braking arrangement for braking the movement of the belt strap can be ensured for protection of the vehicle occupant in the respective driving or crash situation.

The safety belt system according to an embodiment preferably may comprise corresponding sensors for recording the at least one occupant-specific and/or situation-specific parameter. For example sensors for recording the occupant weight and/or occupant position, speed sensors, acceleration sensors, centrifugal sensors, temperature sensors, crash sensors, etc. can be drawn upon as sensors for recording the at least one occupant-specific and/or situation-specific parameter. It is of course possible to refer to already existing sensors in the motor vehicle fitted with the safety belt system according to an embodiment, for example those that serve to control the braking system, insofar as it is possible to connect these sensors to the electronic control unit, for example via a bus system. Alternatively however separate sensors that are connected only to the electronic control unit of the safety belt system according to an embodiment can also be used.

According to an embodiment of the safety belt system the electronic control unit is configured to determine as a function of the at least one occupant-specific and/or situation-specific parameter a reference value for at least one measurement that characterizes the process of braking the movement of the belt strap. The measurement that characterizes the process of braking the movement of the belt strap can be for example the activation force exerted by the actuator and/or the braking force exerted by an activation element of the braking arrangement on the belt roller and/or the belt strap, a distance traveled by the actuator and/or the activation element of the braking arrangement during the braking process or an activation speed of the actuator and/or of the activation element of the braking arrangement during the braking process. The process of braking the movement of the belt strap can be further characterized by a plurality of measurements, such as e.g. a time-dependent characteristic curve showing the activation force exerted by the actuator and/or the braking force exerted by the activation element of the braking arrangement on the belt roller and/or the belt strap, or similar. The electronic control unit can determine the reference value for the at least one measurement that characterizes the process of braking the movement of the belt strap in real time as a function of the at least one occupant-specific and/or situation-specific parameter. Thus the determination of the reference value ensures a rapid reaction to a change in the at least one occupant-specific and/or situation-specific parameter.

The electronic control unit is preferably configured to control the actuator as a function of the reference value for the at least one measurement that characterizes the process of braking the movement of the belt strap. Reference-value dependent controlling of the actuator is relatively simple to realize, and because of the fact that the determination of the reference value takes place in real time as a function of the at least one occupant-specific and/or situation-specific parameter as described above, it guarantees a rapid reaction to a change in the at least one occupant-specific and/or situation-specific parameter.

In a method according to an embodiment for controlling a safety belt system for a motor vehicle, said method comprising a belt roller and a belt strap wound on the belt roller, at least one occupant-specific and/or situation-specific parameter is recorded for example by means of corresponding already existing or separate sensors in the motor vehicle. An actuator that is configured to activate a braking arrangement for braking a movement of the belt strap, with said braking arrangement being equipped with an arrangement for self-energizing of an activation force generated by the actuator, is controlled by means of an electronic control unit as a function of the at least one recorded occupant-specific and/or situation-specific parameter in order to effect a braking of the movement of the belt strap, said braking being adapted to at least one occupant-specific and/or situation-specific parameter.

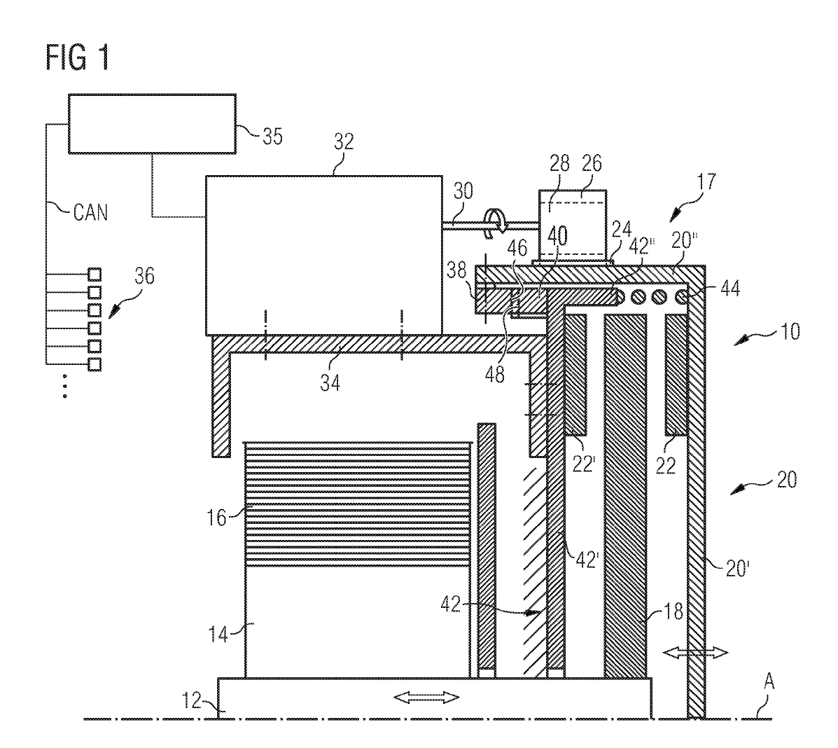

FIG. 1 shows a longitudinal section of a section of a belt retractor 10 for an adaptive safety belt system, said section being located on one side of an axis of rotation A. The belt retractor 10 comprises a belt roller 14 arranged non-rotationally on a floating shaft 12, on which belt roller 14 a belt strap 16 is wound. The shaft 12 is rotatable about the axis of rotation A for unwinding/winding the belt strap 16 on/from the belt roller 14.

A braking arrangement 17 for braking a winding movement of the belt strap 16 from the belt roller 14 comprises a brake disk 18 arranged non-rotationally on the shaft 12 coaxially to the belt roller 14 and is thus rotatable about the axis of rotation A together with the belt roller 14. A first supporting member 20 features a first section 20′ that substantially extends in parallel to the brake disk 18 and that supports a first friction element 22 on the side that faces the brake disk 18. A second section 20″ of the first supporting member 20 extends substantially perpendicularly to the first section 20′ around the external circumference of the brake disk 18. The first supporting member 20 is mounted movably along the axis of rotation A and rotatably about the axis of rotation A by means of a mount that is not shown in FIG. 1.

At its external circumference the second section 20″ of the first supporting member 20 is provided with external toothing 24 that meshes with external toothing 26 of a gear wheel 28. The gear wheel 28 is non-rotationally connected with a motor shaft 30 of an electric motor 32, with the electric motor 32 being positioned radially externally relative to the belt roller 14 and mounted on a fixed casing 34 covering the belt roller 14.

The electric motor 32 is connected to an electronic control unit 35, which is in turn connected via a CAN bus system to sensors 36 for recording occupant-specific and situation-specific parameters, i.e. sensors for recording occupant weight and occupant position as well as speed sensors, temperature sensors, crash sensors, acceleration sensors, centrifugal sensors, etc. The sensors 36 can be existing sensors that already exist in a motor vehicle fitted with the belt retractor 10, for example sensors that serve to control the braking system. Alternatively however the sensors 36 can also be separate sensors that are connected only to the electronic control unit 35 of the belt retractor 10.

A plurality of first wedges 38 are fixed, distributed about an internal circumference of the second section 20″ of the first supporting member 20, to the second section 20″ of the first supporting member 20. A number of second wedges 40 corresponding to the number of first wedges 38 is mounted on an outer surface of a fixed supporting member 42 that is connected to the casing 34, with said outer surface facing away from the brake disk 18. The first and second wedges 38, 40 are oriented such that their transverse wedge surfaces 46, 48 face each other and extend substantially perpendicularly to the axis of rotation A.

A first section 42′ of the second supporting member 42, which substantially extends in parallel to the brake disk 18, supports a second friction element 22′ on the side that faces the brake disk 18. In order to set a distance between the first section 20′ of the first supporting member 20 and the first section 42′ of the second supporting member 42 a return spring 44 is provided, the ends of which support the first section 20′ of the first supporting member 20 and/or support a second section 42″ of the second supporting member 42 that extends substantially perpendicularly to the first section 42′

Lastly the belt retractor 10 features a belt pretensioner that is not shown in FIG. 1, which tightens the belt strap 16 in order to compensate for the belt slack around the body of a vehicle occupant when a vehicle assistance system and/or the sensors 36 detect a hazardous situation or an imminent crash. The electronic control unit 35 that is used to trigger the electric motor 32 can also be used to trigger the belt pretensioner. Alternatively however it is also possible to trigger the belt pretensioner by means of a separate electronic control unit. Mechanical systems having a pre-tensioned spring or pyrotechnic systems in which the tightening of the belt is effected by means of a pyrotechnic propellant are considered suitable as activation mechanisms for the belt pretensioner. Alternatively a highly dynamic electric motor can also be used to activate the belt pretensioner, whereby either the electric motor 32 or an additional electric motor can be used.

The function of the belt retractor 10 is described below. During normal operation of the belt retractor 10 the belt strap 16 is wound on/unwound from the belt roller 14 by rotation of the shaft 12 and the belt roller 14 connected non-rotationally thereto about the axis of rotation A. The brake disk 18, which is also arranged non-rotationally on the shaft 12, is also rotated about the axis of rotation A when the shaft 12 is rotated.

When the driver assistance system or a corresponding sensor 36 such as e.g. a crash sensor identifies a hazardous situation or an imminent crash the electronic control unit 35 first triggers the belt pretensioner whereupon the activation mechanism of the belt pretensioner effects a rotation of the shaft 12 and thus the belt roller 14 and the brake disk 18 about the axis of rotation A. Thus the belt strap 16 is wound on the belt roller 14 and the belt strap 16 is pulled tight against the vehicle occupant's body.

In the crash itself the rotary motion of the shaft 12, the belt roller 14 and the brake disk 18 effected by the belt pretensioner and resulting from the force acting on the belt strap 16 is first stopped. In order to prevent a rotation of the shaft 12, the belt roller 14 and the brake disk 18 in a contrary direction and thus to prevent an unwinding of the belt strap 16 from the belt roller 14 the electric motor 32 must subsequently by activated by the electronic control unit 35.

The electronic control unit accordingly 35 receives occupant-specific and situation-specific parameters from the sensors 36, i.e. parameters that characterize the weight and the actual seating position of a vehicle occupant and parameters that characterize the current speed of the motor vehicle fitted with the belt retractor 10, the crash pulse and the environmental situation such as e.g. the temperature, the the nature of the road or the nature of an obstacle. As a function of these parameters the electronic control unit 35 determines in real time at least one reference value for a measurement that characterizes the process of braking the winding movement of the belt strap 16 from the belt roller 14 such as e.g. a time-dependent reference characteristic curve of the activation force exerted by the electric motor 32. The activation and controlling of the electric motor 32 by the electronic control unit 35 lastly takes place as a function of the at least one reference value for the measurement that characterizes the process of braking the winding movement of the belt strap 16 from the belt roller 14.

During activation of the electric motor 32 a clockwise rotation of the motor shaft is transmitted via the gear wheel 28 to the first supporting member 20. Thus the first supporting member 20 is twisted in a clockwise manner about the axis of rotation A relative to the second supporting member 42. This leads to the transverse wedge surfaces 46 of the first wedges 38 fixed to the second section 20″ of the first supporting member 20 running up against the transverse wedge surfaces 48 of the second wedges 40 fixed to the second supporting member 42, as a result of which the first supporting member 20 is displaced against the force of the return spring 44 axially to the brake disk 18 i.e. to the left in FIG. 1, so that the first friction element 22 connects to the brake disk 18.

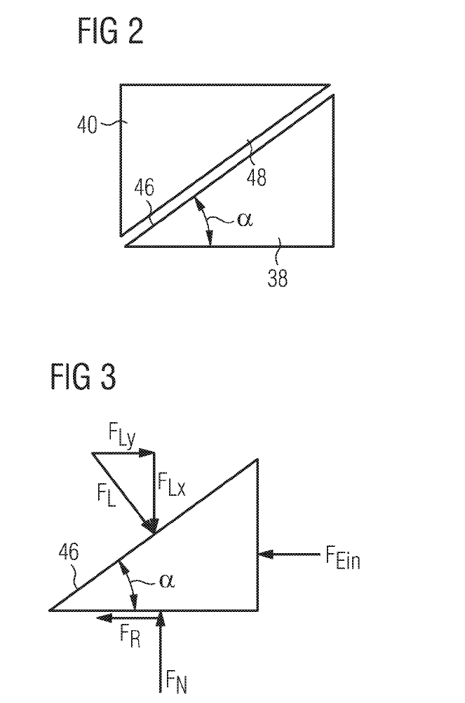

To provide a better overview of the effect of the first and second wedges 38, 40 a plan view of a first wedge arrangement with a first and a second wedge 38, 40 is shown in FIG. 2. The first and the second wedges 38, 40 are arranged so that the transverse wedge surface 46 of the first wedge 38 is opposite the transverse wedge surface 48 of the second wedge 40. A pitch P of the wedge surfaces 46, 48 is determined in each case by a wedge slope angle OC. An axial displacement s of the first supporting member 20 effected by the interaction of the first and second wedges 38, 40 is thus determined by the formula

s=φ−P/(2−n)

in which φ is the angle of rotation of the first supporting member 20 about the axis of rotation A.

Although the wedge arrangement shown in FIG. 2 comprises a first and a second wedge 38, 40 the second wedge 40 can also be replaced by another suitable device such as e.g. a bolt that enables a sliding or rolling support of the first wedge 38. Furthermore a ball and ramp arrangement can also be used in place of the wedge arrangement shown in FIG. 2.

Owing to the floating mounting of the shaft 12, when the first friction element 22 connects to the brake disk 18 the brake disk 18 is displaced together with the first supporting member 20 in the direction of the second supporting member 42 i.e. to the left in FIG. 1. Consequently the brake disk 18 also connects almost without delay to the second friction element 22′.

In the belt retractor 10 shown in FIG. 1 the first supporting member 20, the second supporting member 42 and the first and second wedges 38, 40 represent a self-energizing arrangement i.e. the activation force triggered by the electric motor 32 via the gear wheel 28 is automatically amplified without the application of further external forces.

In order to describe this self-energizing effect the balance of forces on a first wedge 38 resulting from an activation of the electric motor 32 is shown in FIG. 3. Here F_{Ein} is the input force trigged via the electric motor 32 in the first wedge 38 and FL is the reaction force resulting from the transverse wedge surface 46 of the first wedge 38 running up against the transverse wedge surface 48 of the second wedge 40 and supported by the reaction force of the transverse wedge surface 48 of the second wedge 40, said reaction force being divided into a force F_{Ly} that is contrary to the input force F_{Ein} and a compressive force F_{Lx} that is perpendicular to the brake disk 18. F_{N} is the normal force that is contrary to the force F_{Lx} at the brake disk 18 and F_{R} is the friction force arising at the first wedge 38 and/or at the friction elements 22, 22′.

According to this balance of forces the friction force F_{R} and the friction moment at the brake disk 18 pursuant to the following equation

F_{Ein}=−F_{R}·[1−(tan α/μ)]

depend solely on the wedge slope angle CC, a friction coefficient μ between the first and second friction elements 22, 22′ and the brake disk 18, and the input force F_{Ein}. By means of such a self-energizing arrangement the activation force to be exerted by the electric motor 32 in order to achieve a desired braking effect can be significantly reduced. Consequently an electric motor 32 can be used that is compact in design and lightweight.

What is claimed is:

1. A safety belt system for a motor vehicle comprising a belt roller, a belt strap wound on the belt roller, a braking arrangement that can be activated by an actuator for braking a movement of the belt strap, wherein the breaking arrangement is fitted with an arrangement for self-energizing of an activation force generated by the actuator, and wherein the actuator is connected to an electronic control unit that is configured to control the actuator as a function of at least one occupant-specific and/or situation-specific parameter in order to effect a braking of the movement of the belt strap that is adapted thereto.

2. The safety belt system according to claim 1, wherein the electronic control unit is configured to draw on a parameter that characterizes the weight of an occupant of a motor vehicle fitted with the safety belt system and/or that characterizes the seating position of the occupant as the at least one occupant-specific and/or situation-specific parameter.

3. The safety belt system according to claim 1, wherein the electronic control unit is configured to draw on a parameter that characterizes the speed of a motor vehicle fitted with the safety belt system, the crash pulse in a crash and/or one or a plurality of parameter(s) that characterize(s) the environmental situation as the at least one occupant-specific and/or situation-specific parameter.

4. The safety belt system according to claim 1, wherein the safety belt system comprises corresponding sensors for recording the at least one occupant-specific and/or situation-specific parameter.

5. The safety belt system according to the electronic control unit is configured to determine as a function of the at least one occupant-specific and/or situation-specific parameter a reference value for at least one measurement that characterizes the process of braking the movement of the belt strap.

6. The safety belt system according to claim 1, wherein the electronic control unit is preferably configured to control the actuator as a function of the reference value for the at least one measurement that characterizes the process of braking the movement of the belt strap.

7. A method for controlling a safety belt system for a motor vehicle, said system comprising a belt roller and a belt strap wound on the belt roller, the method comprising the following steps:
Recording of at least one occupant-specific and/or situation-specific parameter, and
Controlling of an actuator that is configured to activate a braking arrangement for braking a movement of the belt strap with said braking arrangement being equipped with an arrangement for self-energizing of an activation force generated by the actuator, by means of an electronic control unit as a function of the at least one recorded occupant-specific and/or situation-specific parameter in order to effect a braking of the movement of the belt strap that is adapted thereto.

8. The method for controlling a safety belt system according to claim 7, wherein the electronic control unit draws on a parameter that characterizes the weight of an occupant of a motor vehicle fitted with the safety belt system and/or that characterizes the seating position of the occupant as the at least one occupant-specific and/or situation-specific parameter.

9. The method for controlling a safety belt system according to claim 7, wherein the electronic control unit draws on a parameter that characterizes the speed of a motor vehicle fitted with the safety belt system, the crash pulse in a crash and/or one or a plurality of parameter(s) that characterize(s) the environmental situation as the at least one occupant-specific and/or situation-specific parameter.

10. The method for controlling a safety belt system according to claim 7, further comprising the following step:
Determination by means of the electronic control unit of a reference value for at least one measurement that characterizes the process of braking the movement of the belt strap as a function of the at least one occupant-specific and/or situation-specific parameter.

11. The method according to claim 10, wherein the electronic control unit controls the actuator as a function of the reference value for the at least one measurement that characterizes the process of braking the movement of the belt strap.

12. A safety belt system for a motor vehicle comprising:
a belt roller,
a belt strap wound on the belt roller,
a braking arrangement for braking a movement of the belt strap comprising an arrangement for self-energizing of an activation force;
an actuator for generating the activation force and for activating the braking arrangement, and
an electronic control unit connected to the actuator, the electronic control unit being configured to control the actuator as a function of at least one occupant-specific and/or situation-specific parameter in order to effect a braking of the movement of the belt strap.

13. The safety belt system according to claim 12, wherein the electronic control unit is configured to draw on a parameter that characterizes the weight of an occupant of a motor vehicle fitted with the safety belt system and/or that characterizes the seating position of the occupant as the at least one occupant-specific and/or situation-specific parameter.

14. The safety belt system according to claim 12, wherein the electronic control unit is configured to draw on a parameter that characterizes the speed of a motor vehicle fitted with the safety belt system, the crash pulse in a crash and/or one or a plurality of parameter(s) that characterize(s) the environmental situation as the at least one occupant-specific and/or situation-specific parameter.

15. The safety belt system according to claim 12, wherein the safety belt system comprises corresponding sensors for recording the at least one occupant-specific and/or situation-specific parameter.

16. The safety belt system according to claim 12, wherein the electronic control unit is configured to determine as a function of the at least one occupant-specific and/or situation-specific parameter a reference value for at least one measurement that characterizes the process of braking the movement of the belt strap.

17. The safety belt system according to claim 12, wherein the electronic control unit is preferably configured to control the actuator as a function of the reference value for the at least one measurement that characterizes the process of braking the movement of the belt strap.
